(19) United States
(12) Patent Application Publication
(10) Pub. No.: US 2014/0100096 A1
(43) Pub. Date: Apr. 10, 2014

(54) Thermal expansive aluminum guide roller and production method thereof

(71) Applicant: Shanghai Honghao Enterprise Development CO., LTD., Shanghai (CN)

(72) Inventors: Shengfan Chen, Shanghai (CN); Xiandong Chen, Shanghai (CN); Yuna Jiang, Shanghai (CN); Shengzhen Chen, Shanghai (CN); Fajie Chen, Shanghai (CN)

(73) Assignee: Shanghai Honghao Enterprise Development CO., LTD., Shanghai (CN)

(21) Appl. No.: 14/073,556

(22) Filed: Nov. 6, 2013

(30) Foreign Application Priority Data
Oct. 6, 2012 (CN) 201210439325.0

(51) Int. Cl. F16C 13/00

(52) U.S. Cl. CPC F16C 13/00
USPC 492/54; 29/460

(57) ABSTRACT

A thermal expansive aluminum guide roller includes: an aluminum guide roller base, wherein the aluminum guide roller base is coated by an irony layer, the irony layer is coated by a hard metallic layer. Preferably, the hard metallic layer is a nickel layer or a titanium layer. Aluminum is utilized because of a small density. With the light weight, inertia is small and a rotation speed can be adjusted rapidly for quickly adapting to different conditions while coating. A production method of the thermal expansive aluminum guide roller includes: a step of preparing the aluminum guide roller base, wherein the production method further includes steps of: A) preparing an irony sleeve; B) inserting the aluminum guide roller base into the irony sleeve; C) forming the irony layer; and D) forming a coating layer, wherein the irony layer is coated by a hard metallic layer.

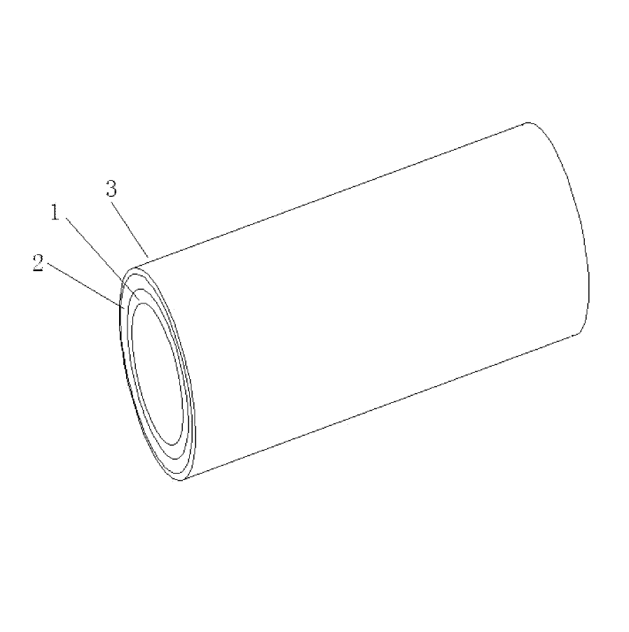

### CROSS REFERENCE OF RELATED APPLICATION

The present invention claims priority under 35 U.S.C. 119(a-d) to CN 201210439325.0, filed Nov. 06, 2012.

### BACKGROUND OF THE PRESENT INVENTION

1. Field of Invention

The present invention relates to a field of mechanical technologies, and more particularly to a guide roller.

2. Description of Related Arts

There are a lot of guide rollers such as feeding roller, cooling roller and flattening roller in a winding vacuum coater. A base film roll is mounted on the feeding roller. The base film of the base film roll surrounds the cooling roller and the flattening roller, and is flattened by the flattening roller. Thereafter, metallic vapor is coated on the flattened base film by a vapor source for completing the coating operation.

Coating needs high accuracy and has strict requirements for the guide roller that the guide roller should be light, hard, sufficient for heat conduction, etc. However, a conventional guide roller cannot meet all the above requirements.

### SUMMARY OF THE PRESENT INVENTION

An object of the present invention is to provide a thermal expansive aluminum guide roller for overcoming the above problems.

Another object of the present invention is to provide a production method of the thermal expansive aluminum guide roller for overcoming the above problems.

Accordingly, in order to accomplish the above objects, the present invention provides:

A thermal expansive aluminum guide roller, comprising:

an aluminum guide roller base, wherein the aluminum guide roller base is coated by an irony layer, the irony layer is coated by a hard metallic layer.

Preferably, the hard metallic layer is a nickel layer or a titanium layer.

The aluminum guide roller base is utilized according to the present invention. Because of a small density of aluminum, the base can meet a requirement of light weight. As a result, the guide roller has a light weight. And with the light weight of the guide roller, inertia thereof is small and a rotation speed thereof can be adjusted rapidly for quickly adapting to different conditions while coating.

The aluminum is soft and is easy to be scratched or damaged, so that the aluminum cannot meet a hardness requirement. For improving hardness, a hard metallic layer may be coated on the aluminum. However, metal is hard to be coated on the aluminum because the aluminum is easy to be oxidized. According to the present invention, the aluminum guide roller base is coated by the irony layer. The irony layer is a transition layer in such a manner that the hard metallic layer such as the nickel layer or the titanium layer can be easily coated.

A production method of the thermal expansive aluminum guide roller is also provided, comprising a step of preparing the aluminum guide roller base, wherein the production method further comprises steps of:

A) preparing an irony sleeve, wherein an internal structure of the irony sleeve matches with an external structure of the aluminum guide roller base; and an internal diameter of the irony sleeve is less than or equals to an external diameter of the aluminum guide roller base;

B) inserting the aluminum guide roller base into the irony sleeve, wherein the irony sleeve is heated for expanding until the internal diameter of the irony sleeve is larger than the external diameter of the aluminum guide roller base; then the aluminum guide roller base is inserted into the irony sleeve; the irony sleeve is cooled in such a manner that the cooled irony sleeve contracts and firmly cases on the aluminum guide roller base;

C) forming the irony layer, wherein the irony sleeve on the aluminum guide roller base is thinned by turning for forming the irony layer; and

D) forming a coating layer, wherein the irony layer is coated by a hard metallic layer.

By the foregoing steps, guide rollers meeting the requirements can be produced.

A thickness of the irony sleeve is 0.2˜0.8 mm, preferably 0.2 mm, for saving materials and preserving the irony sleeve from deformation.

The internal diameter of the irony sleeve is less than the external diameter of the aluminum guide roller base by 1˜4 mm, preferably 2 mm.

The irony sleeve is heated to 150˜500° C. for maintaining sufficient thermal expansion effect and avoiding being too soft.

The irony sleeve is cooled by spraying liquid. Cool water is sprayed on the irony sleeve for rapidly cooling and contracting.

Preferably, the cool water is sprayed around the irony sleeve for evenly cooling.

The irony sleeve is turned until the thickness is 0.2˜2 mm.

Preferably, the irony layer is polished after being turned, so as to ensuring smoothness and facilitating coating the hard metallic layer.

The irony layer is made of tungsten steel for ensuring hardness.

Preferably, the hard metallic layer is coated by electroplating.

Preferably, the metallic layer is made of titanium or nickel.

According to the present invention, guide rollers with light weight, high hardness and sufficient heat conduction can be produced.

These and other objectives, features, and advantages of the present invention will become apparent from the following detailed description, the accompanying drawing, and the appended claims.

### BRIEF DESCRIPTION OF THE DRAWING

The FIGURE is a perspective view of a thermal expansive aluminum guide roller according to a preferred embodiment of the present invention.

### DETAILED DESCRIPTION OF THE PREFERRED EMBODIMENT

For clearly explaining methods, characteristics, objects and functions, referring to the drawings, the present invention is further illustrated.

Referring to the drawing, a thermal expansive aluminum guide roller is provided, comprising:

an aluminum guide roller base 1, wherein the aluminum guide roller base is coated by an irony layer 2, the irony layer 2 is coated by a hard metallic layer 3.

Preferably, the hard metallic layer 3 is a nickel layer or a titanium layer.

The aluminum guide roller base is utilized according to the present invention. Because of a small density of aluminum, the base can meet a requirement of light weight. As a result, the guide roller has a light weight. And with the light weight of the guide roller, inertia thereof is small and a rotation speed thereof can be adjusted rapidly for quickly adapting to different conditions while coating.

The aluminum is soft and is easy to be scratched or damaged, which means the aluminum cannot meet a hardness requirement. For improving hardness, a hard metallic layer should be coated on the aluminum. However, metal is hard to be coated on the aluminum because the aluminum is easy to be oxidized. According to the present invention, the aluminum guide roller base 1 is coated by the irony layer 2. The irony layer 2 is a transition layer in such a manner that the hard metallic layer 3 such as the nickel layer or the titanium layer can be easily coated.

A production method of the thermal expansive aluminum guide roller is also provided, comprising a step of preparing the aluminum guide roller base 1, wherein the production method further comprises steps of:

A) preparing an irony sleeve, wherein an internal structure of the irony sleeve matches with an external structure of the aluminum guide roller base 1; and an internal diameter of the irony sleeve is less than or equals to an external diameter of the aluminum guide roller base 1;

B) inserting the aluminum guide roller base 1 into the irony sleeve, wherein the irony sleeve is heated for expanding until the internal diameter of the irony sleeve is larger than the external diameter of the aluminum guide roller base 1; then the aluminum guide roller base 1 is inserted into the irony sleeve; the irony sleeve is cooled in such a manner that the cooled irony sleeve contracts and firmly cases on the aluminum guide roller base 1;

C) forming the irony layer 2, wherein the irony sleeve on the aluminum guide roller base 1 is thinned by turning for forming the irony layer 2; and

D) forming a coating layer, wherein the irony layer 2 is coated by a hard metallic layer 3.

By the foregoing steps, guide rollers meeting the requirements can be produced.

A thickness of the irony sleeve is 0.2˜0.8 mm, preferably 0.2 mm, for saving materials and preserving the irony sleeve from deformation. The internal diameter of the irony sleeve is less than the external diameter of the aluminum guide roller base 1 by 1˜4 mm, preferably 2 mm.

The irony sleeve is heated to 150˜500° C. for maintaining sufficient thermal expansion effect and avoiding being too soft. The irony sleeve is cooled by spraying liquid. Cool water is sprayed on the irony sleeve for rapidly cooling and contracting.

Preferably, the cool water is sprayed around the irony sleeve for evenly cooling. The irony sleeve is turned until the thickness is 0.2˜2 mm. Preferably, the irony layer 2 is polished after being turned, so as to ensuring smoothness and facilitating coating the hard metallic layer. The irony layer is made of tungsten steel for ensuring hardness. Preferably, the hard metallic layer is coated by electroplating. Preferably, the metallic layer is made of titanium or nickel.

According to the present invention, guide rollers with light weight, high hardness and sufficient heat conduction can be produced.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A thermal expansive aluminum guide roller, comprising:
an aluminum guide roller base, wherein said aluminum guide roller base is coated by an irony layer, said irony layer is coated by a hard metallic layer.

2. The thermal expansive aluminum guide roller, as recited in claim 1, wherein said hard metallic layer is a nickel layer.

3. The thermal expansive aluminum guide roller, as recited in claim 1, wherein said hard metallic layer is a titanium layer.

4. A production method of the thermal expansive aluminum guide roller, comprising a step of preparing the aluminum guide roller base, wherein the production method further comprises steps of:
A) preparing an irony sleeve, wherein an internal structure of the irony sleeve matches with an external structure of the aluminum guide roller base; and an internal diameter of the irony sleeve is less than or equals to an external diameter of the aluminum guide roller base;
B) inserting the aluminum guide roller base into the irony sleeve, wherein the irony sleeve is heated for expanding until the internal diameter of the irony sleeve is larger than the external diameter of the aluminum guide roller base; then the aluminum guide roller base is inserted into the irony sleeve; the irony sleeve is cooled in such a manner that the cooled irony sleeve contracts and firmly cases on the aluminum guide roller base;
C) forming the irony layer, wherein the irony sleeve on the aluminum guide roller base is thinned by turning for forming the irony layer; and
D) forming a coating layer, wherein the irony layer is coated by a hard metallic layer.

5. The production method, as recited in claim 4, wherein a thickness of the irony sleeve is 0.2˜0.8 mm.

6. The production method, as recited in claim 5, wherein the internal diameter of the irony sleeve is less than the external diameter of the aluminum guide roller base by 1˜4 mm.

7. The production method, as recited in claim 4, wherein the irony sleeve is heated to 150˜500° C.

8. The production method, as recited in claim 4, wherein the irony sleeve is cooled by spraying liquid, cool water is sprayed on the irony sleeve for rapidly cooling and contracting.

9. The production method, as recited in claim 4, wherein the irony sleeve is turned until the thickness is 0.2˜2 mm.

10. The production method, as recited in claim 4, wherein the irony layer is made of tungsten steel.
